(19) United States
(12) Patent Application Publication
(10) Pub. No.: US 2005/0147297 A1
(43) Pub. Date: Jul. 7, 2005

(54) Unsupervised data segmentation

(76) Inventors: Robert Ainsley McLaughlin, Oxford (GB); Julia Alison Noble, Oxford (GB)

Correspondence Address: NIXON & VANDERHYE, PC, 1100 N GLEBE ROAD, 8TH FLOOR, ARLINGTON, VA, 22201-4714, US

(21) Appl. No.: 10/506,468

(22) PCT Filed: Mar. 4, 2003
(86) PCT No.: PCT/GB03/00891

(30) Foreign Application Priority Data
Mar. 4, 2002 (GB) 0205000.3

(51) Int. Cl. G06K 9/00; G06K 9/34; G06K 9/62

(52) U.S. Cl. 382/171; 382/173; 382/224

(57) ABSTRACT

An unsupervised method of segmenting data sets using a region growing technique in which data points are initially assigned to a single class, new classes are seeded and points in the data set tested by calculating the probability that they belong to the new class. The probability distributions used in the calculation are adapted as points are reassigned. Classes which fail to grow are discarded. The technique may be applied to the segmentation of data sets in which the data points are taken from medical images. The method may be applied to the demarcation of different parts of structures, e.g. in the medical field demarcating an aneurysm from the surrounding blood vessels in an image or 3-D model of a patient's vasculature. The method may involve using a shape descriptor which is representative of the shape of the structure at each point under consideration. Thus the different parts are distinguished on the basis of their shape.

The present invention relates to a method and apparatus for unsupervised data segmentation which is suitable for assigning multi-dimensional data points of a data set amongst a plurality of classes. The invention is particularly applicable to automated image segmentation, for instance in the field of medical imaging, thus allowing different parts of imaged objects to be recognised and demarcated automatically.

In the field of automated data processing it is useful to be able to recognise automatically different groups of data points within the data set. This is known as segmentation and it involves assigning the data points in the data set to different groups or classes.

An example of a field in which segmentation is useful is the field of image processing. A typical imaged scene contains one or more objects and background, and it would be useful to be able to recognise reliably and automatically the different parts of the scene. Typically this may be done by segmenting the image on the basis of the different intensities or colours appearing in the image. Image segmentation is applicable in a wide variety of imaging applications such as security monitoring, photo interpretation, examination of industrial parts or assemblies, and medical imaging. In medical imaging, for instance, it is useful to be able to distinguish different types of tissue or organs or to distinguish abnormalities such as an aneurysm or tumour from normal tissue. Currently, particularly in medical imaging, segmentation involves considerable input from a clinician in an interactive method.

For example, there have been proposals for methods of demarcating an aneurysm in an image of vasculature. A brain aneurysm is a localised persistent dilation of the wall of a blood vessel. Visually, it appears that part of the vessel has ballooned out. When the ballooning vessel pops, it will often result in the death of the patient. There are several possible treatments for an aneurysm including surgery (clipping) or filling the aneurysm with coils. The type of treatment is dependent upon factors such as aneurysm volume, neck size and the location of the aneurysm in the brain. The methods proposed involve first identifying the aneurysm neck, then labelling all pixels on one side of the neck as forming the aneurysm, while pixels on the other side are identified as part of the adjoining vessel. Such techniques are described in R. van der Weide, K. Zuiderveld, W. Mali and M. Viergever, “CTA-based angle selection for diagnostic and interventional angiography of saccular intracranial aneurysms”, IEEE Transactions on Medical Imaging, Vol. 17, No. 5, pp831-341, 1998 and D. Wilson, D. Royston, J. Noble and J. Byrne, “Determining X-ray projections for coil treatments of intracranial aneurysms”, IEEE Transactions on Medical Imaging, Vol. 18, No. 10, pp973-980, 1999. However, these techniques also rely on manual intervention for starting the segmentation.

Techniques of segmentation using region-splitting or region growing are well known, see for example: Rolf Adams and Leanne Bischof, “Seeded Region Growing”, IEEE Transactions on Pattern Analysis and Machine Intelligence, Vol. 16, No. 6, pp641-647, June, 1994. However, these techniques require that the number of regions into which the data set is to be segmented is known in advance. Thus the techniques are not generally applicable to fully automatic methods.

Segmentation techniques in which there is no initial assumption of the number of classes found in the data set are referred to as “unsupervised” segmentation techniques. An unsupervised segmentation algorithm has been proposed in Charles Kervrann and Fabrise Heitz, “A Markov Random Field model-based approach to unsupervised texture segmentation using local and global spatial statistics”, Technical Report No. 2062, INRIA, October, 1993. This utilises an augmented Markov Random Field, where an extra class label is defined for new regions, and a parameter is pre-set to define the probability assigned to this extra state. Any points in the data set which are modelled sufficiently badly (assigned a low probability by the existing classes) will be assigned to this new class. At each iteration of the algorithm, connected components of such points are collated into new classes.

However, typical problems with unsupervised techniques are under-segmentation (in which data points are added to inappropriate classes) and over-segmentation (in which the data is divided into too many classes).

One aspect of the present invention provides an unsupervised segmentation method which is generally applicable to multi-dimensional data sets. Thus, it allows for completely automatic segmentation of the data points into a plurality of classes, without any prior knowledge of the number of classes involved.

In more detail this aspect of the invention provides an unsupervised segmentation method for assigning multi-dimensional data points of a selected data set amongst a plurality of classes, the method comprising the steps of:
(a) defining an initial class encompassing all data points of the selected data set;
(b) defining a second class by selecting a data point and assigning it to the second class together with data points within a first predetermined neighbourhood of the selected data point;
(c) testing each data point lying within a second predetermined neighbourhood of data points in the second class by calculating the probability that each said data point belongs to the first class and the probability that it belongs to the second class, and assigning it to the second class if the probability that it belongs to the second class is higher;
(d) said probability calculations being adapted during said method in dependence upon the assignment of the points to the classes.

The probability calculations may comprise the steps of determining a probability distribution of a property of the data points in the initial class and determining a probability distribution of said property of the data points in the second class, and comparing the data point under test with the two probability distributions. The probability calculations may also comprise the step of multiplying the probability derived from the probability distribution with an a priori probability derived, for example, from the proportion of points in the neighbourhood in the various classes.

The calculation of probability may be adapted as the method proceeds by recalculating the probability distributions as data points are assigned to the classes. The distributions will alter as the number of data points in the data points varies. This adaptation may take place every time a point is reassigned, or after a few points have been reassigned. The probability distributions may be calculated on the basis of histograms with bins of unequal width. The bin widths may be set by reference to the initial data set, e.g. to give a substantially equal number of counts in each bin.

Thus another aspect of the invention provides a method of histogram equalisation in which the bin sizes are set to give an initially substantially uniform number of counts in each bin. Thus the histogram sensitivity can be adapted to the specific application by an analysis of the entire data set.

In the segmentation method the classes continue to grow as more data points are assigned to them. Preferably the method continues until no more data points are added to the class, at which point another class may be defined and then grown by repeating the method steps.

The selection of the data point for initiating a class may be random, or it may be optimised, for example by ordering the remaining points based on the probability distribution.

Preferably classes are discarded (or “culled”) if they fail to grow, i.e. if they fail to have data points assigned to them when all necessary points have been tested. This is particularly useful in avoiding over-segmentation of the data set. Segmentation is concluded when all of the classes formed in turn on the basis of the data points remaining in the initial class have been discarded.

A predetermined neighbourhood of a data point d is an open set that contains at least the data point itself. One example is the open ball of radius r which contains all data points within a distance r of the data point d, though other shapes are possible and may be appropriate for different situations. In extreme cases, a neighbourhood may contain only the data point itself, or may contain the entire data set. The first and second predetermined neighbourhoods may be defined only on the spatial position of the data points, for instance in the application of the technique to an image where the aim is to segment the image into the different parts of the imaged object. However, in other data sets the neighbourhoods may be defined in a parameter space containing the data points.

Where the technique is applied to image segmentation, the data points may comprise a descriptor of at least a part of an object in the image and the spatial coordinates of that part. The descriptor may be representative of the shape, size, intensity (brightness), colour or any other detected property, of that part of the object.

Rather than taking the data points from the image itself, they may be taken from a spatial model fitted to the image, such as a 3-D mesh fitted to the image or its segmentation. This is particularly useful where the descriptor is a descriptor of the shape of the object.

The image may be a volumetric image or a non-invasive image, and for example may be an image in the medical field or industrial field (e.g. a part x-ray).

Another aspect of the invention provides a method of demarcating different parts of a structure in a representation of the structure, comprising the steps of calculating for each of a plurality of data points in the representation at least one shape descriptor of the structure at that point, and segmenting the representation on the basis of said at least one shape descriptor.

The representation may be an image of the structure, or may be a 3-D model of the structure (which could be derived by various imaging modalities). The results may be displayed in the form of a visual representation of the structure, with the parts distinguished, for instance by being shown in different colours.

The descriptor may comprise values representing cross-sectional size or shape of the structure at that point. The values may be lateral dimensions of the structure at that point, or a measure of the mean radius of rotation.

Another aspect of the invention provides a way of calculating a shape descriptor by defining a volume, e.g. a spherical volume, and changing the size of the volume, e.g. growing it, until a predefined proportion of it is filled by the structure.

The descriptors may be used to segment the representation automatically, for example using an unsupervised segmentation method such as the method in accordance with the first aspect of the invention.

The image may be a volumetric image or a non-invasive image, and for example may be an image in the medical field or industrial field (e.g. a part x-ray). In the medical field the method may be used to demarcate an aneurysm from vasculature, or to demarcate other protrusions.

The invention extends to a computer program comprising program code means for executing the methods on a suitably programmed computer. Further, the invention extends to a system and apparatus for processing and displaying data utilising the methods.

The invention will be further described by way of example, with reference to the accompanying drawings in which:

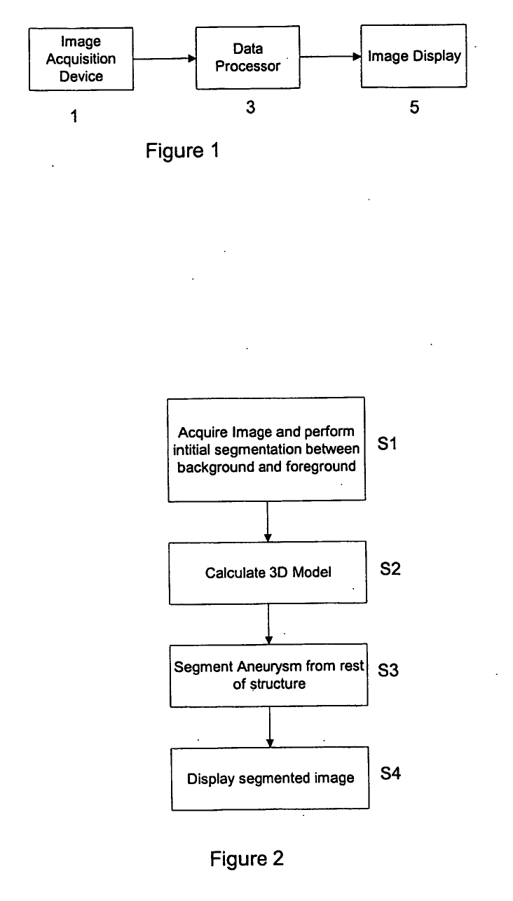

FIG. 1 illustrates schematically an imaging system in accordance with one embodiment of the invention;

FIG. 2 is a flow diagram of one embodiment of the invention;

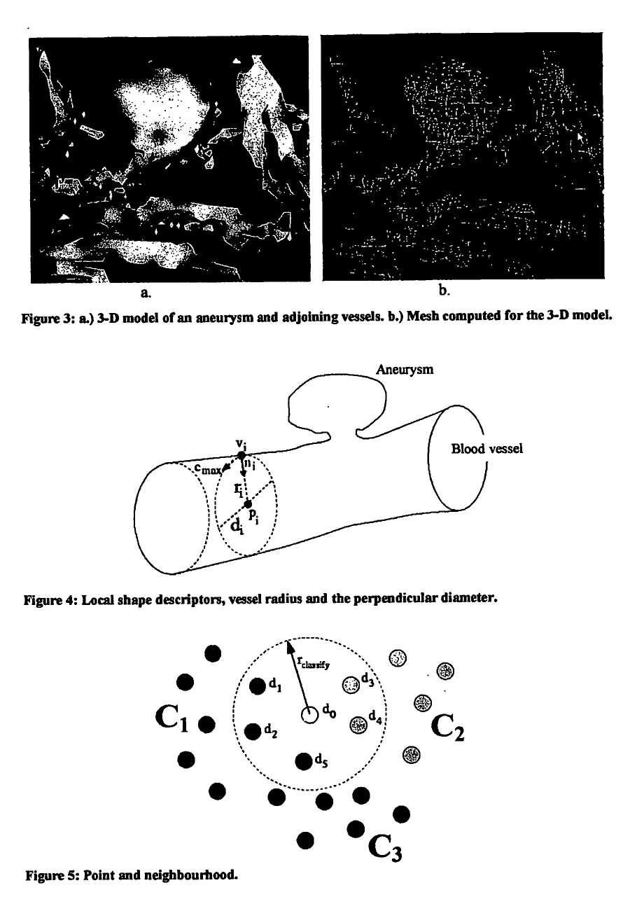

FIGS. 3A and 3B show respectively a 3-D model of an aneurysm and adjoining vessels and a mesh computed for the 3-D model;

FIG. 4 illustrates schematically a blood vessel and aneurysm indicating the shape descriptors used in an embodiment of the present invention;

FIG. 5 illustrates the concepts of data point classes and regions used in one embodiment of the present invention;

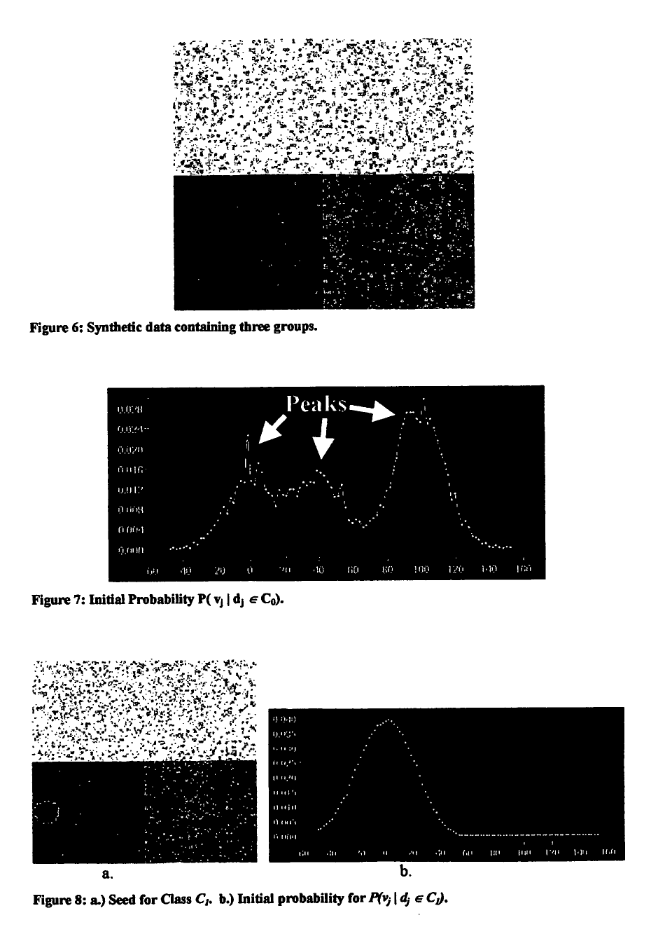

FIG. 6 illustrates a synthetic data set containing three groups of data points;.

FIG. 7 illustrates an initial probability distribution for the data set of FIG. 6;

FIGS. 8A and 8B illustrate respectively a newly seeded class in the data set of FIG. 6 and the initial probability distribution for that class;

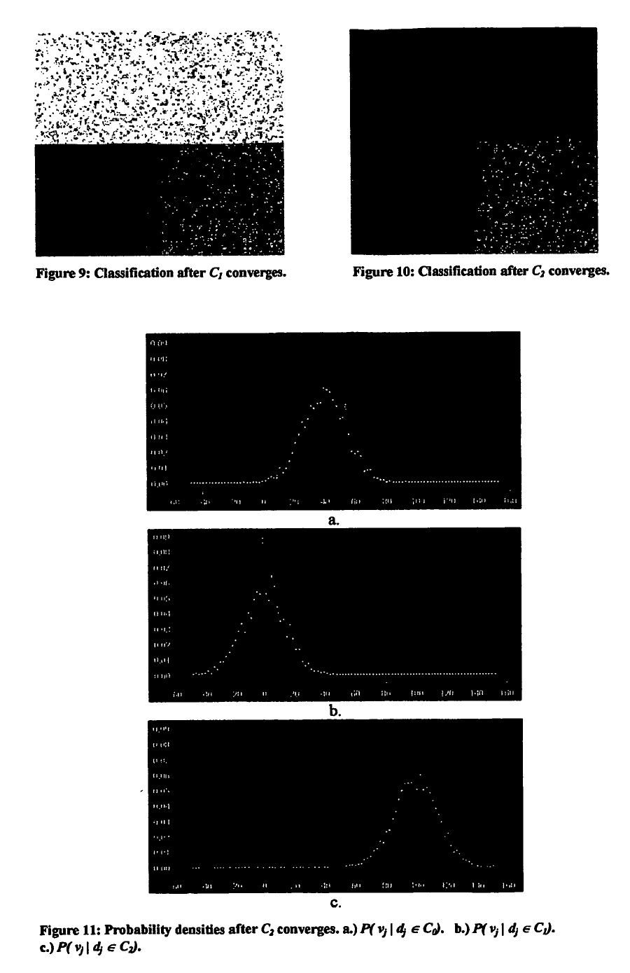

FIG. 9 illustrates the classification after the class of FIG. 8 has converged;

FIG. 10 illustrates the classification after a further class has converged;

FIGS. 11A, B and C illustrate probability densities for the classes in FIG. 10;

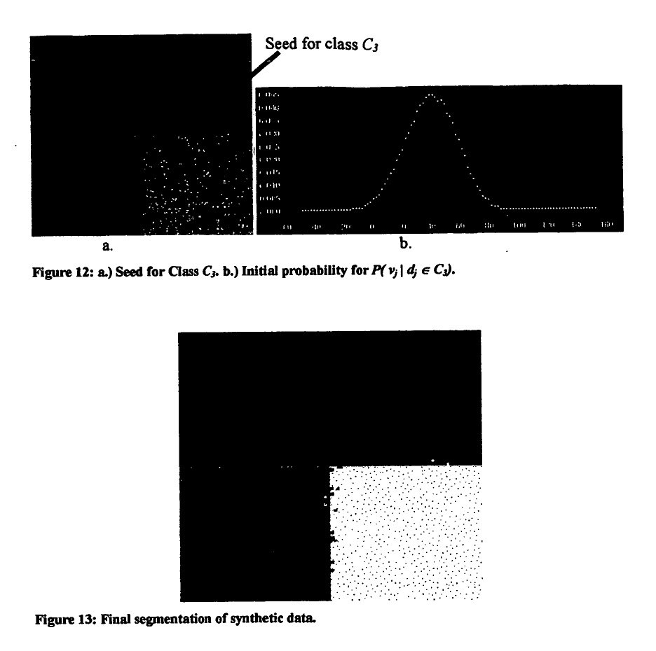

FIGS. 12A and B illustrate the seeding of a further class and its initial probability distribution;

FIG. 13 illustrates the final segmentation of the data set of FIG. 6 achieved with one embodiment of the present invention;

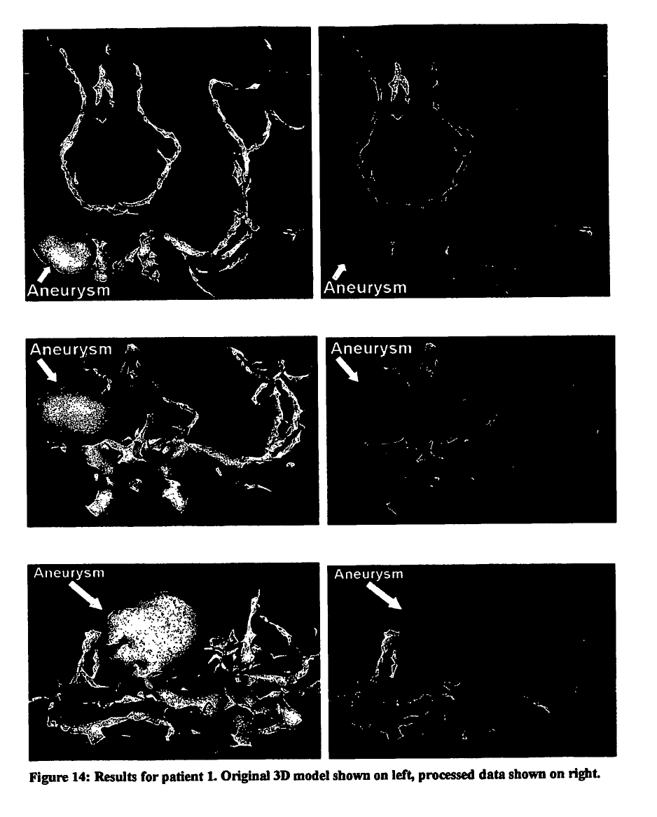

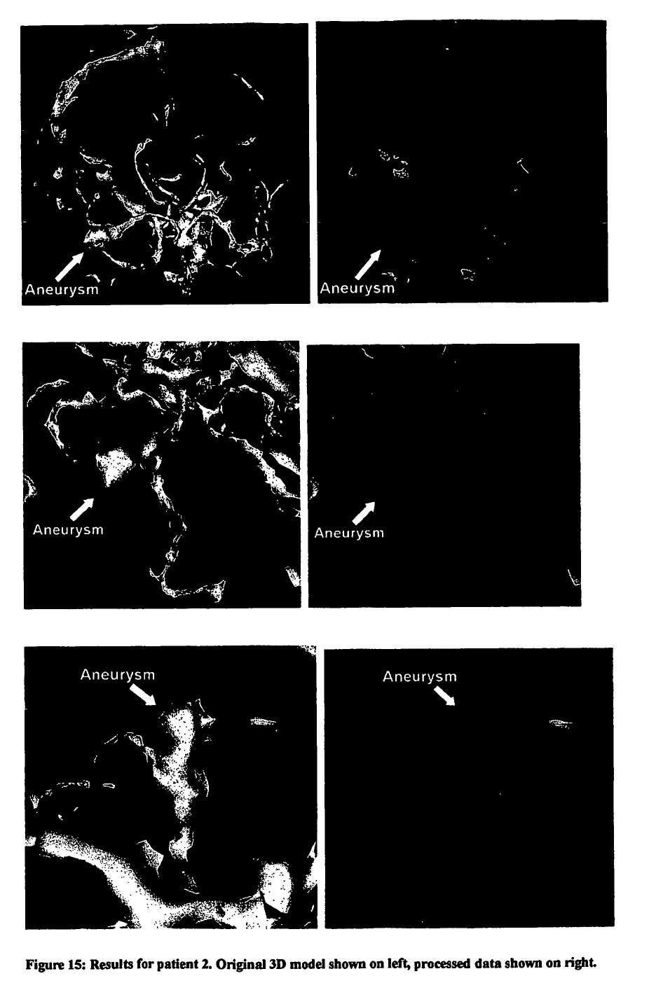

FIGS. 14 and 15 illustrate the results of applying the image segmentation method of an embodiment of the invention to medical images;

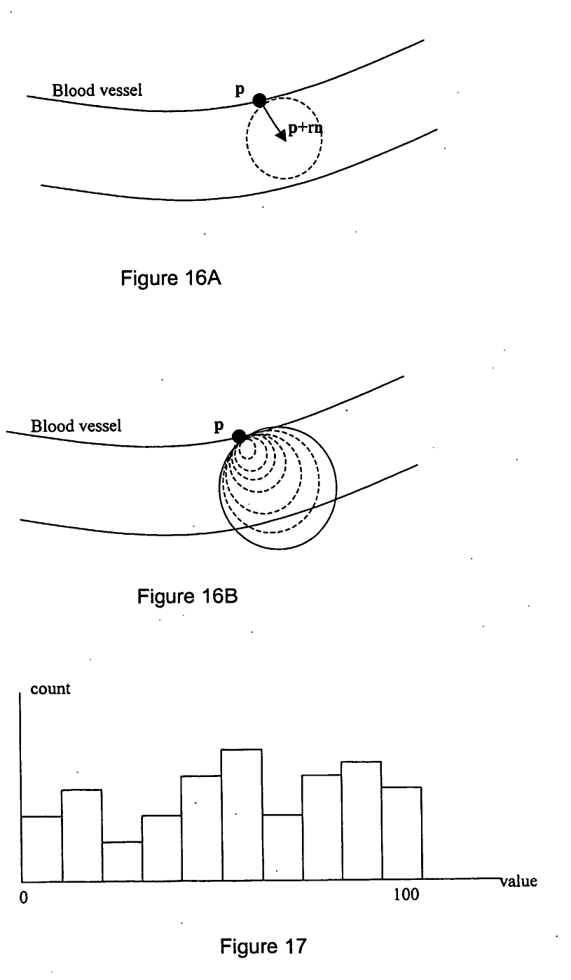

FIGS. 16A and B illustrate another example of the shape descriptor calculated according to an embodiment of the invention;

FIG. 17 illustrates a typical prior art histogram;

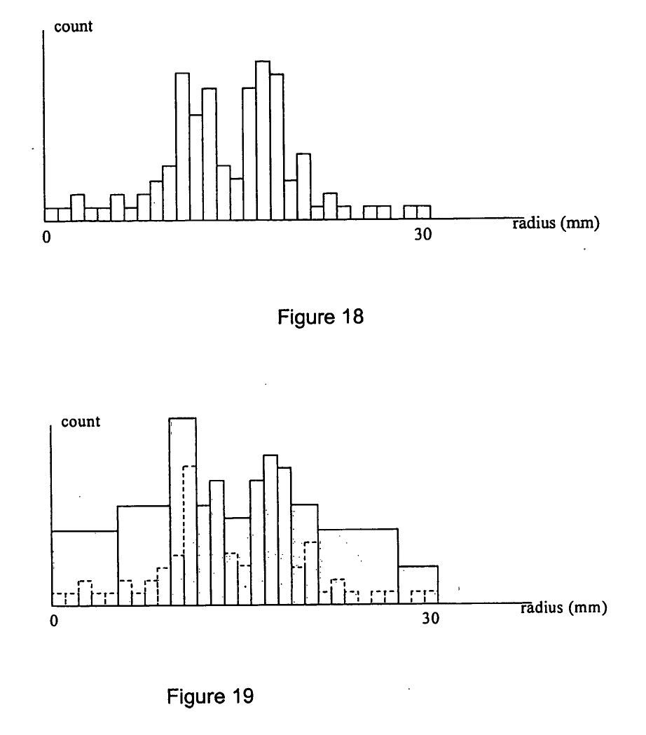

FIG. 18 illustrates a typical histogram of vessel radius in an image of vasculature; and

FIG. 19 illustrates a modified histogram in accordance with an embodiment of the present invention.

An embodiment of the invention applied to the shape based segmentation of an image of vasculature including an aneurysm and to the intensity based segmentation of a synthetic image will be described below. However, it will be appreciated that the segmentation technique is applicable to the segmentation of general data sets having data points in n-dimensions, where each data point has m numeric values. Thus it may be applied, for example, to intensity-based segmentation, for instance of ultrasound, MRI, CTA, 3-D angiography or colour/power Doppler data sets, to the segmentation of PC-MRA data where a scan provides information on the speed (intensity) and an estimated flow direction, and to unsupervised texture segmentation as well as object segmentation of parts based on geometry.

FIG. 1 illustrates schematically the apparatus used in one embodiment of the invention which comprises an image acquisition device 1, a data processor 3 and an image display 5. The operation of the apparatus is illustrated schematically by the flow diagram of FIG. 2 and involves the general steps acquiring the image in step s1 and performing an initial segmentation to distinguish foreground (blood vessels and aneurysm) from background (tissue and air), calculating a 3-D model in step s2, then performing a second segmentation in step s3 to distinguish the aneurysm from the normal vaculature, and displaying the final segmented image in step s4. The aneurysm and related blood vessels may be imaged using a 3-D imaging modality such as MRA, CTA or 3-D Angiography. The initial segmentation within step si may be carried out by standard techniques such as A. C. S Chung and J. A. Noble, “Fusing magnitude and phase information for vascular segmentation in phase contrast MR angiograms”, Proceedings Medical Image Computing and Computer Assisted Intervention. (MICCAI), pp. 166-175, 2000 and D. L. Wilson and J. A. Noble, “An Adaptive Segmentation Algorithm for Time-of-Flight MRA Data”, IEEE Transactions on Medical Imaging, Vol. 18, No. 10, pp 938-945, October, 1999, IEEE. Other techniques are available for other imaging modalities. Thus an image in which the foreground (blood) has been separated from the background (tissue and air) is obtained.

The segmented image can then be used to produce a 3-D model of the vessels and aneurysm. Given such a 3-D model, it is useful to demarcate the aneurysm, identifying where it connects to the major vessel. This allows the estimation of aneurysm volume and neck size and other geometry-related parameters, and hence aids the clinician to choose the appropriate treatment for a particular patient and possibly to use the information in the actual treatment (eg to select views of the aneurysm). In this embodiment the aneurysm is demarcated by first computing a triangular mesh over the 3-D model. Such a mesh can be computed using an established mesh method such as the marching cubes algorithm (see, for example, W. E. Lorensen and H. E. Cline, “Marching Cubes: A High Resolution 3D Surface Construction Algorithm”, Computer Graphics, Vol. 21, No. 3, pp 163-169, July, 1987). An example of a 3-D model showing an aneurysm and the adjoining vessels, and its associated mesh is illustrated in FIGS. 3A and B. The aneurysm is the large ballooning section near the centre of the image.

The aneurysm segmentation of step s3 will be carried out in this embodiment by computing and using a shape descriptor, i.e. a description of the shape of the vasculature at that point. Two methods for doing this will be described.

1) As a first example of a shape descriptor at each vertex in the triangular mesh, a local description of the vessel shape is computed in the form of two values representing the radius and diameter of the vessel at that point, as shown in FIG. 4. Taking the unit surface normal n, to the mesh at a particular vertex vᵢ, a ray is extended from vᵢ, into the vessel and the distance to the opposite side of the vessel is measured, e.g. by stepping along the ray and testing whether the voxel is still foreground (within the vessel) or background (outside the vessel). Halving this value gives an estimate of the vessel radius rᵢ at vᵢ. This estimate of vessel radius is the first of two descriptor values that are computed.

Using rᵢ the point pᵢ is defined as an estimate of the vessel centre, defined as pᵢ=vᵢ+rᵢnᵢ

The two directions of principal curvature on the mesh, that is the directions in which the curvature of the mesh at vᵢ are a maximum and minimum can then be estimated. Denoting these directions as cₘₐₓ and cₘᵢₙ, where the absolute value of cₘₐₓ is larger than the absolute value of cₘᵢₙ, a vector from pᵢ in the directions of cₘₐₓ and −cₘₐₓ is extended, measuring the distance in each direction to the vessel surface. Adding these two distances together gives an estimate of the vessel diameter dᵢ in a direction perpendicular to nᵢ.

The two values (rᵢ, dᵢ) form the shape descriptor which characterises the vessel at the point vᵢ, and are computed for vertices of the mesh over the whole image or area of interest.

2) A problem with the method above is that error in the estimation of the surface normal could have a large effect on the ray that is extended through the vessel, and hence on the estimated value of diameter. An example of a shape measure which is more robust in the presence of noise will now be described with reference to FIGS. 16A and 16B.

With this shape measure, only a single scalar value is computed for each point on the vessels. This will be an approximation of the mean radius of rotation of the vessel (i.e. the inverse of the mean curvature).

Thus, given a point p on the vessel, first estimate the normal vector n to the vessel, such that the normal is pointing inwards towards the centre of the vessel. There are several well-known methods to do this such as “Computer Graphics Using OpenGL”, F. S. Hill, Jr., Published by Prentice Hall, 2^{nd} edition, 2001. Then define a spherical neighbourhood with radius r that is centred on the point p+rn, where r is some small scalar quantity. Note that, by definition, this spherical neighbourhood will include the point p on its boundary.

Now count the number of foreground voxels (i.e. vasculature and aneurysm) that lie in the neighbourhood and divide this by the total number of voxels in the neighbourhood. This ratio is an estimate of the proportion of the neighbourhood that lies within the vessel. Voxels that intersect the neighbourhood are considered to lie within the neighbourhood. However, excluding these voxels would have little effect upon the final results.

Then increase the size of the neighbourhood until it no longer lies within the vessel. Thus a sequence of neighbourhoods is defined, with increasingly larger values of r, each of which is centred on p+rn and each of which has a boundary that touches the point p. When the proportion of foreground voxels in the neighbourhood falls below some pre-defined threshold value, the method steps. In this implementation, 0.8 was used as the threshold value.

The radius of the final neighbourhood before exceeding the threshold is recorded, and taken to be indicative of the radius of the vessel. The process is then repeated at each point on the surface of the vessels.

In summary, at each surface point a spherical neighbourhood is grown until it has outgrown the vessel, and then the final radius is taken as indicative of the vessel radius.

The first shape measure above is very local in nature. Slight variations in the estimation of the surface normal could have a large effect on the estimates of diameter. The second shape measure is integral in nature. That is, the value computed is the result of a summation process of many voxels, making it less susceptible to noise in a small number of voxels.

In addition, the second shape measure is more robust when an aneurysm is somewhat ellipsoid in shape, rather than spherical. This is because the mean radius of curvature is estimated, rather than two estimates of the radius in perpendicular directions.

Recall that the neighbourhood size is increased until the proportion that lies within the aneurysm falls below some threshold value (0.8 in this implementation). If this threshold value is set to 1.0, then the process of increasing the size of the neighbourhood is terminated as soon as a boundary of the aneurysm is breached. With a threshold of 1.0, the estimated radius will be an estimate of the minimum radius. By choosing a smaller value for the threshold, some proportion of the neighbourhood is tolerated to lie outside of the aneurysm. For an aneurysm that is ellipsoid in nature (rather than spherical), this allows for a better estimate of the mean radius. Importantly, this means that a similar value will be computed at all points on the aneurysm. If the minimum radius is being estimated, then different values will be estimated at different points on the aneurysm.

It should be noted that it is not necessary to compute the shape descriptor at every vertex on the mesh (which typically has tens of thousands of vertices—probably at a much finer resolution than the image). Instead a subset can be taken, e.g. an arbitrary point for each voxel on the surface of the vessel (i.e. neighbours a background vessel). For example, the top, left-hand corner of each surface voxel could be used.

Whichever shape descriptor is used, the next task is to segment the data set to demarcate the aneurysm, i.e. to group together points that lie on the aneurysm and to distinguish these from points on the adjoining vessels. This will allow the aneurysm to be demarcated. Points lying along the single blood vessel will have similar values of shape descriptor. At the neck of the aneurysm, these values will change rapidly. Passing over the neck and onto the aneurysm itself, there will be a similarity in the values on the aneurysm.

Segmentation is achieved in this embodiment by using a region splitting algorithm. The algorithm separates the points on the triangular mesh into regions (sub-parts) that are similar. Each vessel should be identified as a sub-part, while the aneurysm will form a different sub-part.

Firstly, to illustrate the concepts used in the segmentation method it will be helpful to consider the simple set of points illustrated in FIG. 5. Suppose the task is to classify data point d₀. It is assumed that it must be in the same class as one of the other five data points that lie within the dotted circular neighbourhood, i.e. within a distance r_{classify} of the data point under consideration. Of these, as indicated in FIG. 5, dᵢ and d₂ belong to class C₁; d₃ and d₄ belong to class C₂; and d₅ belongs to class C₃. The point d₀ will be classified depending upon some property which it holds in common with the data points in one of the other classes. This property may, for example, be its intensity or colour if the points are pixels in an image, or a shape descriptor such as that described above in connection with the task of aneurysm demarcation, and can be a scalar or n-vector quantity. The approach in this embodiment is to calculate the probabilities in turn that the point d₀ is in each of the classes C₁, C₂ or C₃, and then to assign it to the class for which the probability is the highest. In this embodiment the probability will be the product of two terms. The first is a probability that is independent of the property of interest of d₀. The second is a probability based on the value of the property (for example intensity or shape descriptor) of the point and a comparison with the distribution of such values in each of the three classes.

Taking the first of those probabilities, there are several ways of calculating this probability. One way is to set it as being directly proportional to the number of data points of each class within the radius r_{classify}. For example, referring to FIG. 5, this probability term as regards class C₁ would be 2/5 because 2 of the 5 points within the distance r_{classify} are points of class C₁. There are other possibilities, such as setting the probability in accordance with the Euclidean distance in real or parameter space between the various points. This term, which does not depend on the value of the property of interest at the data point, is known as the “a priori” probability.

The second term, based on the value of the property of interest of point d₀ (such as intensity or shape descriptor) is, in this embodiment, obtained by comparing the value of the property for d₀ to the distribution of such values in the three classes C₁, C₂, C₃. This will be described below with reference to a specific intensity-based example illustrated in FIG. 6. FIG. 6 illustrates a data set which consists of intensity values. The aim is to segment this image automatically into the three regions or classes which are clearly visible. The first step is to assign all data points (in this case pixels) to a single initial class C₀. Then the probability distribution (in this case of intensity on a gray scale) over the class C₀ is calculated. In this case it is calculated by computing a histogram of the values of intensity (i.e. binning the intensity values, counting the number of values within each bin, and normalising the total count to 1). (A development of the histogram calculation will be discussed below). The histogram is then smoothed using Parzen windows by convolving the values in the histogram using a kernel function. The kernel function used in this embodiment is the Gaussian function, although others may be used. This smoothing function is adaptive as will be explained below. The result is the initial probability distribution as illustrated in FIG. 7. Incidently, in FIG. 7 three peaks corresponding to the three classes of FIG. 6 can be seen.

The next step is to start or “seed” a new class. This is achieved by choosing a data point, defining a neighbourhood of radius r_{seed} around it, and assigning all points within the neighbourhood to the new class C₁. This is illustrated in FIG. 8A. In some embodiments the point may be chosen randomly, although in other embodiments the points in the data set may be ordered for selection, for instance in accordance with how badly they are modelled by the remaining class. It can be seen that the new class C₁ happens to be in the bottom left-hand area of the image. Then the probability distribution of intensity values is calculated for the class C₁ in just the same way as the probability distribution above (namely by forming a histogram and then smoothing it). This probability distribution is illustrated in FIG. 8B.

It was mentioned above that the smoothing is adaptive; In this embodiment this is achieved by making the variance of the Gaussian kernel function dependent upon the number of data points in the class. This greatly affects the probability distribution produced. When the histogram comprises only a small number of values, it is appropriate to use a large variance. This results in heavy smoothing. If the histogram consists of a large number of values, it is more likely that the probability distribution accurately reflects the underlying distribution, and so a small variance is appropriate, resulting in less smoothing. The variance may be defined as a function of the number of data points in a class, such that as the number of data points in the class increases, the variance decreases. In this example, the variance is inversely proportional to the square of an affine function of the size of the class. Other functions are possible. For example, the variance may be inversely proportional to the natural logarithm of the number of data points in the class.

Note that functions other than a Gaussian can be used as the kernel function for the Parzen window estimate of the probability distribution. In this case, some property of the kernel function comparable to the Gaussian's varianice will be adjusted as a class grows or shrinks.

The next step is to test data points near the class C₁ to check whether they can be assigned to class C₁ not. In this embodiment all points dⱼ are tested which lie within a radius r_{classify} of any point in the class C₁. The testing involves selecting a point dⱼ and computing the probabilities that this point belongs to class C₀ or C₁. For each class, this involves computing two values, which are multiplied together to compute the probability.

The first value is the a priori probability that dⱼ belongs to each class. As mentioned above this probability is independent of the value of the property of interest. In this example it is taken as the proportion of points within a radius r_{seed} of dⱼ that are in the relevant class, as explained in relation to FIG. 5.

The second value is computed by comparing the value of the property of interest (intensity or shape descriptor etc) with the probability distributions computed for the class. For classes C₀ and C₁ these probability distributions are shown in FIGS. 7 and 8B. Thus, for example, if the point dⱼ has an intensity corresponding to the value 20 on the horizontal axis of the distribution, the value for class C₀ can be read off as 0.010 whereas the value for class C₁ can be read off as about 0.027. These values are multiplied with the a priori probabilities to give the probability that data point dⱼ belongs to either class C₀ or C₁. In the example of the two values that we have quoted, where dⱼ has an intensity of 20, if the a priori probabilities are of a similar magnitude, then class C₁ will have a higher probability and the data point will be assigned to class C₁.

Thus the class C₁ grows with each point that is assigned to it. The testing is repeated recursively, choosing all points within a radius r_{classify} of each point added to class C₁ and testing whether they should be reclassified to class C₁. It should be noted that only points which are currently in class C₀ are considered (in other words reclassified points are not subsequently reconsidered). It is important to note, though, that each time a point is reassigned, the probability distributions for the two classes are recalculated with a new variance for the Gaussian kernel set in accordance with the change in the number of points. Where there are a large number of data points such that the probability distribution does not vary much as a single point is reassigned, the recalculation of the probability distribution need not occur every time a point is reassigned, but after a preset number of points have been reassigned. This means that the probability distribution varies adaptively as the classification process proceeds.

The variance used, therefore, when computing the probability that a point under test belongs to the initial class C₀ will increase as points are removed from the class, and, the variance used to compute the probability that the point belongs to class C₁ will decrease as that class grows. In this way, C₁ will improve its model of the distribution of numeric values for the property of interest in the class, and this distribution will be removed gradually from the three distributions that together formed the distribution for class C₀ illustrated in FIG. 7.

The process of testing points for addition to class C₁ is continued until no new points within a radius r_{classify} of the existing points in the class are added. This is the situation indicated in FIG. 9. If viewed graphically, the class C₁ appears to “flood-fill” out to the borders of the class as shown in FIG. 9.

Then the process is repeated by seeding a new class C₂ on a point in class C₀ and growing that class. Whilst growing the class C₂, when testing whether to reassign some point dⱼ from class C₀ to class C₂, it may be found that points from class C₁ also lie within a neighbourhood of radius r_{classify} of dⱼ. In this case, it is tested whether to assign data point dⱼ to class C₀, C₁ or C₂.

After this second class C₂ has converged, the data will be classified into C₀, C₁ and C₂ as shown in FIG. 10. FIG. 11 shows the probability distributions for the three classes.

Because this is an unsupervised algorithm, the process does not, of course, “know” that there are no more classes of points. Therefore the process will continue by seeding a new class C₃ as shown in FIG. 12A. The initial probability distribution for class C₃ is shown in FIG. 12B. However, this class will, in fact, not grow in the way that C₁ and C₂ did. The algorithm is designed to discard classes which do not grow (by reclassifying their points back to class C₀). The reason that class C₃ does not grow will be explained. First, because C₃ contains fewer points than C₀, the probability distribution is generated by convolving with a Gaussian kernel function with a large variance. Thus it is more smoothed than the probability distribution for the remaining points in C₀. This results in lower probabilities being read off for values from the underlying distribution. It will be seen that in FIG. 12B the maximum probability is 0.045, while the maximum for the remaining class C₀ is 0.06 as shown in FIG. 11A. Thus as class C₃ attempts to grow, by testing data points, most points will not be re-classified from C₀ to C₃, but will remain instead in C₀. If the class does not grow sufficiently it will be “culled”. The growth is tested against a threshold. In this example if, at convergence, a class is less than three times as large as when it was seeded it is culled. Other criteria, for example based on the rate of growth, are possible. In this way the algorithm does not introduce an excessive number of classes to the segmentation.

In practice the algorithm continues to attempt to seed new classes on each of the points left in C₀, but each new class will be culled. The final segmentation is shown in FIG. 13. It can be seen that the segmentation is fairly accurate.

It should be noted that the algorithm can be applied again within each of the classes C₀, C₁, C₂ to check for segmentation within those classes. Thus each class is taken in turn, all its data points regarded as an initial class and a new class seeded within it, the method then proceeding as before.

The data set need not comprise all data points available (e.g. all pixels in the image or all points in the model). A subset of the data points may be selected to optimise the segmentation (e.g. by excluding obvious outliers). In addition, not all data points in a class may be used in the computation of the probability distribution. A subset of the data points may be selected (e.g. by excluding outliers according to some statistical test).

The algorithm therefore involves segmenting a data set by initially assigning all points to a single class and then randomly seeding and growing new classes. The probability distributions in the classes are adaptive and this, together with the culling of classes which do not grow, means that over-segmentation is avoided.

In the description above the histograms were computed in a fairly typical fashion by finding the minimum and maximum values to be included, and then separating the interval between these into equally sized bins. Each value will then be assigned to a bin, and the probability computed for a particular value will equal the number of points in that bin, divided by the total number of points in the histogram. This is illustrated in FIG. 17.

This works well if there is a uniform prior probability of getting any particular numerical value. However, this is rarely the case in real applications.

Consider the example of a histogram of the radius of points on blood vessels. Imagine that the minimum sized vessel that can be detected has a radius of 11 mm, and that the largest vessel in the brain has a radius of 30mm. This is quite a realistic value if the patient has a giant aneurysm. There will be many vessels with a radius in the range 3 mm-9 mm, but very few in the range 20 mm-30 mm

The problem arises that when grouping the surface points on a vessel, if the radius changes from 6 mm to 9 mm, then this probably indicates that a new vessel has been reached. However, if in a large vessel the radius changes from 26 mm to 29 mm (again a difference of 3 mm), then this merely indicates variation in the vessel radius. The fundamental issue is that a small change in radius is important in the first instance, but not the second.

One solution is to try to normalise the change by dividing by the vessel radius, so as to measure a ratio of change in vessel diameter. However, this approach has a serious limitation.

In real data, there are likely to be few small vessels (in fact, there will be many small vessels, but the scan will detect very few of them because of its finite resolution, so for the purposes of processing the data that is scanned, there will be few small vessels) and few extremely large vessels, but many medium-sized vessels. Thus if vessel diameter changes from 1 mm to 2 mm or 25 mm to 30 mm, it is likely to be because of noise or natural variation. However, if vessel size changes from 10 mm to 13 mm, then this probably indicates that a change of vessel. Simply normalising by dividing by vessel radius does not take this into account, and will result in an algorithm that is overly sensitive to variation in small vessels.

As an aside, mathematically the problem can be constructed as trying to define a metric space of ‘vessel radii’. This is a 1-D space, where each point is a possible vessel radius, and where the distance between two points in the space is indicative of how likely it is that the points lie on the same vessel. The metric for this space is non-linear. Two points with radii 26 mm and 29 mm would be considered very close in the metric space, but two points with radii 6mm and 9mm are not close (i.e. the difference likely indicates that they lie on different vessels). The earlier approach of dividing by the vessel radius was an attempt to make the metric linear by a-simple process of normalisation. This does not work as it becomes overly sensitive to changes in small vessel radii. A further embodiment of the invention involves a solution to the problem of estimating the metric on this non-linear space, where the true metric is estimated from the data. It is assumed that, given the true metric for the space, the data would be uniformly spread over the space. Thus the metric can be estimated by examining the density of points under a linear metric, and warping the space so that these points are spread uniformly.

The method begins by computing the vessel radius at all surface points. A realistic histogram is shown in FIG. 18, where there are many medium sized vessels.

This is then used to define a second histogram, where the bin sizes are not equal, but the data count in each bin is approximately equal. Let N be the total number of data points and let b be the number of bins desired for histogram. The technique is to separate the histogram in FIG. 18 into b bins, each containing at least (N/b) entries, as shown in FIG. 19. The original histogram entries are shown dashed. Note that this second histogram necessarily contains less bins than the first histogram did. To compute the histogram, the method starts with the lowest value in the histogram of FIG. 18, and incrementally widen the bin until it includes at least (N/b) entries. Then begin a new bin. Note that some bins contain more points than others. This effect is because each time a bin is widened, all the values are added from a bin in FIG. 18. This effect reduces as the number of bins in the initial histogram increases (i.e. FIG. 19).

Examining the histogram of FIG. 19, note that the bins are wide where there was little data (i.e. small and large values), and narrow where there was much data (medium sized values).

This method is applied to the segmentation technique above by performing the computation of these bin sizes as an initial stage of processing, performed before grouping the vessel surface points into different vessels. Thus the sequence of steps is as follows:
1. Estimate vessel radius for each surface point in the 3D model.
2. Compute a histogram with equal bin size for all of the data (FIG. 18).
3. Compute a second histogram with bins of unequal size, but with approximately equal counts in each bin (FIG. 19).
4. Proceed with the grouping algorithm as before, i.e.:
   i. Assign all points to a single group G₀. Compute a histogram of the values in this group. Smooth the histogram only a small amount, because there is a large amount of data.
   ii. Seed a new group G₁ with a small neighbourhood of points. Compute a histogram of the values in this new group. Smooth the histogram a large amount, because there is a small amount of data.
   iii. For each point in G₀ that lies near G₁, compute the probability assigned to its numeric value (vessel radius) by both G₀ and G₁. If a higher probability was computed from the histogram of G₁, then reassign the point to G₁.
   iv. Repeat with new points in G₀ that are near G₁.
   v. When no more points can be added to G₁, count the number of points in G₁. If the size falls below some threshold value, then discard the group G₁.
   vi. Repeat, seeding a new group G₂ in a different location.

The important change is that when histograms are computed in the algorithm, it now uses the bins that were computed in Step 3 (shown in FIG. 19), rather than equal sized bins. There will be a higher concentration of bins for medium sized vessels, where it is important to distinguish between small changes in vessel radius, and less bins for very small or large vessels, where slight changes are less important.

As a side note, because of the way that the unequal histogram bins are computed, the initial histogram computed in Step 4i for G₀ will have roughly an equal number of values in all bins. However, this will change once entries start being removed and assigned to groups G₀, G₂, G₃, etc . . .

Thus this development adapts the sensitivity of the histogram to a specific application, from an initial analysis of the entire data set.

Incidently it is applicable to more than the immediate application above. It may be applied to the grouping of data representing scans of body parts other than the head. More generally, the data need not be medical in nature. For example, the points may indicate pixel coordinates in a satellite image, and the numerical value for each point indicate the intensity of that pixel. In this case, the grouping algorithm would separate up the image into different objects. More generally still, this algorithm may be applied to any 2-D image in a similar way. It may also be applied to 3D range data. In short, it is applicable in any application where there is a set of data points, provided that each point has some spatial location, and each point has a numeric value assigned to it. More generally, this histogram equalisation process may be coupled with other algorithms. That is, it need not only be applied in the context of the grouping algorithm proposed here. Instead, it may be used as part of any algorithm that requires the computation of a histogram.

Returning to applying the algorithms above to the problem of demarcation of an aneurysm, instead of intensity values, the shape descriptor is used. Thus, referring to FIG. 3, the 3-D model of the aneurysm and blood vessels is calculated from an image of the vasculature and a triangular mesh is defined over the model. At various points on the mesh the shape descriptor, e.g. two-dimensional data points (rᵢ, dᵢ) or spherical radius (r), are computed which describe the shape of the vessel or aneurysm at that point. The algorithm is then applied by initially assigning all points to the same region, and then seeding a new region somewhere on the mesh. The method attempts to grow this new region. If it does not grow, it is culled. At completion, the mesh is separated into the appropriate regions, with the aneurysm separated from its adjoining vessels on the basis of its shape descriptor.

FIGS. 14 and 15 show the application of an embodiment of the invention to two clinical data sets. The results for two patients with aneurysms are shown and in each case the three views of the 3-D brain model are shown on the left, and the segmented results on the right. In each case the aneurysm present is successfully identified.

The method can, of course, be applied also to intensity-based segmentation, such as the segmentation of B-mode ultrasound follicle images where it has successfully demarcated regions indicating follicles. The method is also applicable to the segmentation of MRI, CTA, 3-D angiography and colour/power Doppler sets where blood can be distinguished from other tissue type by its intensity.

1. An unsupervised segmentation method for assigning multi-dimensional data points of a selected data set amongst a plurality of classes, the method comprising the steps of:
(a) defining an initial class encompassing all data points of the selected data set;
(b) defining a second class by selecting a data point and assigning it to the second class together with data points within a first predetermined neighbourhood of the selected data point;
(c) testing each data point lying within a second predetermined neighbourhood of data points in the second class by calculating the probability that each said data point belongs to the first class and the probability that it belongs to the second class, and assigning it to the second class if the probability that it belongs to the second class is higher; and
(d) said probability calculations being adapted during said method in dependence upon the assignment of the points to the classes.

2. A method according to claim 1 wherein the probability calculations comprise the steps of determining a probability distribution of a property of the data points in the initial class and determining a probability distribution of said property of the data points in the second class and comparing the data point under test with said probability distributions.

3. A method according to claim 1 wherein said calculation is adapted by recalculating said probability distributions as data points are assigned to classes.

4. A method according to claim 3 wherein said probability distributions are recalculated on the basis of the number of data points in each class.

5. A method according to claim 4 wherein said probability distributions are recalculated after each assignment of a data point.

6. A method according to claim 2 wherein the probability distributions are calculated on the basis of histograms of the data points.

7. A method according to claim 6 wherein the histograms have bins of unequal width.

8. A method according to claim 7 wherein the widths of the bins of the histograms are set to give an initially approximately equal number of counts in each bin.

9. A method according to claim 1 wherein steps (b), (c) and (d) are repeated iteratively testing in step (c) data points lying within the second predetermined neighbourhood of data points assigned to the second class.

10. A method according to claim 9 wherein steps (b) to (d) are repeated iteratively until no more data points are added to the second class.

11. A method according to claim 1 further comprising the step of defining a third class by selecting a data point from the initial class and assigning it to the third class together with data points within the first predetermined neighbourhood of the selected data point, and repeating the method iteratively with respect to the third class.

12. A method according to claim 1 further comprising the step of discarding any class which fails to have sufficient data points assigned to it in step (c) according to a predetermined criterion, by reassigning its data points to the initial class, when all data points within said predetermined neighbourhood have been tested.

13. A method according to claim 12 further comprising the step of concluding the segmentation when all classes formed in turn on the basis of selecting each of the data points remaining in the initial class have been discarded.

14. A method according to claim 1 wherein said first and second predetermined neighbourhoods are open spheres centred on the data point and having a predetermined radius.

15. A method according to claim 1 wherein said first and second predetermined neighbourhoods are defined on a parameter space containing the data points.

16. A method according to claim 1 wherein said data points are derived from an image, said classes corresponding to different physical parts in said image.

17. A method according to claim 16 wherein said property of said data points comprises a descriptor of at least part of an object in the image and the spatial coordinates of that part.

18. A method according to claim 17 wherein the descriptor comprises at least a value representing the shape of at least part of said object.

19. A method according to claim 18 wherein the descriptor comprises at least a value representing the size of at least part of said object.

20. A method according to claim 16 wherein the image is a medical image.

21. A method according to claim 16 wherein the image is a volumetric image or non-invasive image.

22. A method according to claim 17 wherein the data points are taken from a spatial model fitted to said image.

23. A method of demarcating different parts of a structure in a representation of the structure, comprising the steps of calculating for each of a plurality of data points in the representation at least one shape descriptor of the structure at that point, and segmenting the representation on the basis of said at least one shape descriptor.

24. A method according to claim 23 wherein the descriptor comprises at least one value representing the cross-sectional size of the structure at that point.

25. A method according to claim 24 wherein the at least one value representing the cross-sectional size comprises the lateral dimensions of the structure at that point.

26. A method according to claim 24 wherein the at least one value comprises a measure of the mean radius of rotation of the structure as said point.

27. A method according to claim 23 wherein the at least one value is calculated by defining a volume at said point and changing the size of the volume until a predefined proportion of the volume is filled by the structure.

28. A method according to claim 27 wherein the volume is a spherical volume.

29. A method according to claim 23 wherein the representation is segmented automatically.

30. A method according to claim 29 wherein the representation is segmented using an unsupervised segmentation method.

31. A method according to claim 23 wherein the representation is segmented by hand.

32. A method according to claim 23 wherein the structure is in the human or animal body.

33. A method according to claim 23 wherein the representation is a medical image.

34. A method according to claim 23 wherein the image is a volumetric or non-invasive image.

35. A method according to claim 23 wherein the representation is a model of the structure.

36. A method according to claim 23 wherein the segmentation method is an unsupervised segmentation method for assigning multi-dimensional data points of a selected data set amongst a plurality of classes comprising the steps of:
(a) defining an initial class encompassing all data points of the selected data set;
(b) defining a second class by selecting a data point and assigning it to the second class together with data points within a first predetermined neighbourhood of the selected data point;
(c) testing each data point lying within a second predetermined neighbourhood of data points in the second class by calculating the probability that each said data point belongs to the first class and the probability that it belongs to the second class, and assigning it to the second class if the probability that it belongs to the second class is higher; and
(d) said probability calculations being adapted during said method in dependence upon the assignment of the points to the classes.

37. A computer program comprising program code means for executing on a programmed computer the method of claim 1.

38. Apparatus for segmenting a data set of multi-dimensioned data points, the apparatus comprising:
means for receiving the data set;
a data processor for segmenting the data set in accordance with the method of claim 1; and
a display device for displaying the segmented data set.

39. Apparatus according to claim 38 wherein the means for receiving the data set comprises an acquisition device for acquiring the data set from a subject.

40. Apparatus for demarcating different parts of a structure in a representation of the structure, the apparatus comprising:
means for receiving said representation in the form of a data set;
a data processor for processing said data set to demarcate the different parts of the structure in accordance with the method of claim 23.

41. A computer program comprising program code means for executing on a programmed computer the method of claim 23.
